(19) United States
(12) Patent Application Publication
(10) Pub. No.: US 2013/0101752 A1
(43) Pub. Date: Apr. 25, 2013

(54) METHOD FOR DEPOSITING CYCLIC THIN FILM

(71) Applicants: Hai Won Kim, Gyeonggi-do (KR); Sang Ho Woo, Gyeonggi-do (KR)

(72) Inventors: Hai Won Kim, Gyeonggi-do (KR); Sang Ho Woo, Gyeonggi-do (KR)

(73) Assignee: EUGENE TECHNOLOGY CO., LTD., Gyeonggi-do (KR)

(21) Appl. No.: 13/808,111

(22) PCT Filed: Aug. 1, 2011
(86) PCT No.: PCT/KR2011/005650

§ 371 Date: Jan. 3, 2013

(30) Foreign Application Priority Data
Aug. 2, 2010 (KR) 10-2010-0074608

(51) Int. Cl. B05D 3/14

(52) U.S. Cl. CPC B05D 3/145
USPC 427/539; 427/535

(57) ABSTRACT

Provided is a method of depositing a cyclic thin film that can provide excellent film properties and step coverage. The method includes the steps of depositing an insulating film by repeatedly performing a deposition step for depositing silicon on a substrate by injecting a silicon precursor into a chamber into which the substrate is loaded, a first purge step for removing a non-reacted silicon precursor and a reacted byproduct from the chamber, a reaction step for forming the deposited silicon as an insulating film including silicon by supplying a first reaction gas into the chamber and a second purge step for removing a non-reacted first reaction gas and a reacted byproduct from the chamber; and densifying the insulating film including silicon by supplying a plasma atmosphere into the chamber.

### TECHNICAL FIELD

The present disclosure relates to a method of depositing a cyclic thin film and more particularly, to a method of depositing a cyclic thin film, which forms an insulating film including silicon.

### BACKGROUND

With the advance of semiconductor industries and the requirements of users recently, electronic devices are being more highly integrated and have high performance, and thus semiconductor devices that are the main components of the electronic devices are also required to be highly integrated and have high performance. However, it is difficult to realize a fine structure for highly integrating semiconductor devices.

For example, a thinner insulating film is required for realizing the fine structure, but if the insulating film is formed to a thin thickness, film properties such as insulation characteristic are degraded. Also, it is becoming more difficult to form a thin film with a thin thickness while obtaining excellent step coverage.

### SUMMARY

The object of the present invention is to resolve the above-mentioned problem and to provide a method of deposing an insulating film having excellent film properties and step coverage. Particularly, the present invention provides a method of depositing a cyclic thin film having excellent film properties and step coverage.

The other objects of the present invention will be more clearly understood through the following detailed description and the accompanying drawings.

According to an aspect, there is provided a method of depositing a cyclic thin film comprising the steps of depositing an insulating film by repeatedly performing a deposition step for depositing silicon on a substrate by injecting a silicon precursor into a chamber into which the substrate is loaded, a first purge step for removing a non-reacted silicon precursor and a reacted byproduct from the chamber, a reaction step for forming the deposited silicon as an insulating film including silicon by supplying a first reaction gas into the chamber and a second purge step for removing a non-reacted first reaction gas and a reacted byproduct from the chamber; and densifying the insulating film including silicon by supplying a plasma atmosphere into the chamber.

The first reaction gas may be one or more gases selected from a group consisting of O₂, O₃, N₂, and NH₃.

The insulating film including silicon may be a silicon oxide film or silicon nitride film.

The step of densifying the insulting film including silicon may comprise forming the plasma atmosphere by injecting one or more ignition gases selected from a group consisting of Ar, He, Kr, and Xe.

The reaction step may use O_{*} (oxygen radical) or O_{2—} (oxygen anion), formed by using plasma at an O₂ atmosphere, as the first reaction gas.

The step of densifying the insulting film including silicon may inject the ignition gas and one or more second reaction gases selected from the group consisting of O₂, O₃, N₂, and NH₃.

The step of depositing insulating film may be performed while maintaining a pressure inside the chamber as 0.05 Torr to 10 Torr.

The step of densifying the insulting film including silicon may be performed while maintaining a pressure inside the chamber as 0.05 Torr to 10 Torr.

The deposition step, the first purge step, the reaction step, and the second purge step may be repeatedly performed three to ten times before the step of densifying the insulting film including silicon.

The steps of depositing the insulating film and densifying the insulting film including silicon may be repeatedly performed.

### BRIEF DESCRIPTION OF THE DRAWINGS

FIG. 1 is a flowchart illustrating a method of depositing a cyclic thin film, according to an embodiment of the present invention.

FIG. 2 is a sectional view schematically illustrating a semiconductor manufacturing apparatus for performing a method of depositing a cyclic thin film, according to an embodiment of the present invention.

FIG. 3 is a diagram for describing a method of depositing a cyclic thin film, according to an embodiment of the present invention.

FIG. 4A to 4C are sectional views illustrating a step of depositing silicon, according to an embodiment of the present invention.

FIG. 5A to 5C are sectional views illustrating a step of forming an insulating film including silicon, according to an embodiment of the present invention.

FIG. 6 is a sectional view illustrating an insulating film formed of a plurality of silicon, according to an embodiment of the present invention.

FIG. 7A to 7C are sectional views illustrating a step of densifying an insulating film, according to an embodiment of the present invention.

FIG. 8 is a sectional view illustrating an insulating film formed of silicon, according to another embodiment of the present invention.

### DETAILED DESCRIPTION OF EMBODIMENTS

Hereinafter, embodiments according to the inventive concept of the present invention will be described in more detail with reference to the accompanying drawings. However, embodiments of the inventive concept of the present invention may be modified in various forms, and the scope and spirit of the present invention should not be construed as being limited by the below-described embodiments. Embodiments according to the inventive concept of the present invention are provided such that those skilled in the art can more completely understand the present invention. In the accompanying drawings, like reference numeral refers to like element. Furthermore, various elements and regions in the accompanying drawings are schematically illustrated. Therefore, the present invention is not limited by relative sizes or intervals illustrated in the accompanying drawings.

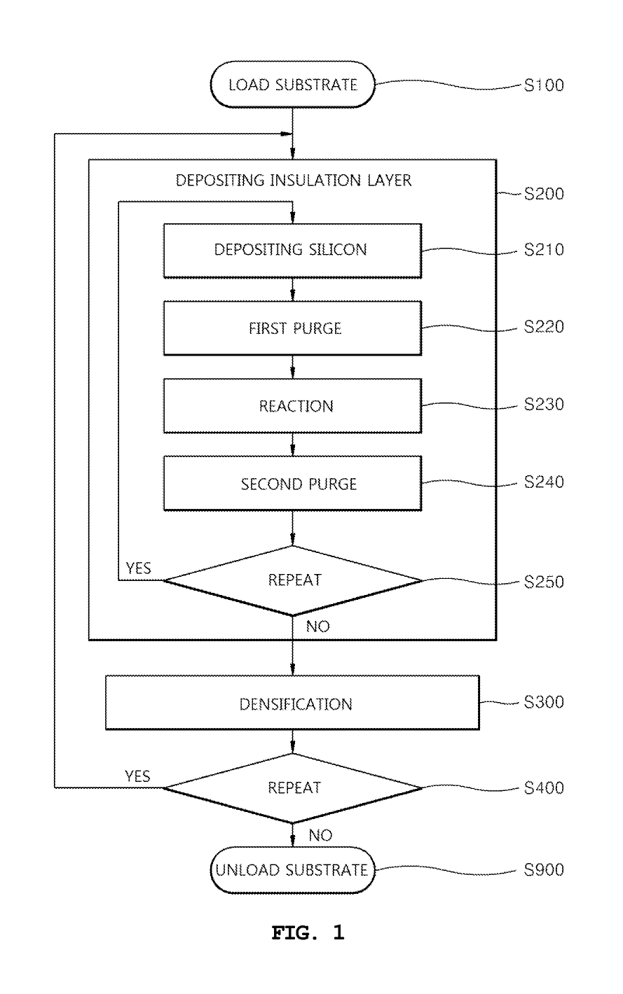

FIG. 1 is a flowchart illustrating a method of depositing a cyclic thin film according to an embodiment of the present invention.

Referring to FIG. 1, a substrate is loaded into a chamber of a semiconductor manufacturing apparatus S100. An insulating film is deposited on the substrate loaded into the chamber S200, and in the step S200, a silicon deposition step S210, a first purge step S220, a reaction step S230 and a second purge step S240 are performed together to deposit the insulating film.

In the step S210, silicon is deposited on the substrate by injecting a silicon (Si) precursor into the chamber for depositing silicon. After silicon is deposited on the substrate, the first purge step of removing a non-reacted silicon precursor and a reaction byproduct is performed in the step S220.

Subsequently, the reaction step for forming an insulating film including silicon by reacting silicon formed on the substrate with a reaction gas is performed in the step S230. For example, the insulating film including silicon may be a silicon oxide film or a silicon nitride film.

To form silicon as the insulating film including silicon, a first reaction gas may be injected into the chamber. The first reaction gas, for example, may be one or more gases selected from the group consisting of O₂, O₃, N₂, and NH₃.

When the insulating film including silicon is the silicon oxide film, the first reaction gas may be a gas including an oxygen atom such as O₂ or O₃. Alternatively, the first reaction gas may be O_{*} (oxygen radical) or O_{2—} (oxygen anion) that is formed of plasma at an O₂ atmosphere. When the insulating film including silicon is the silicon nitride film, the first reaction gas may be a gas including a nitrogen atom such as N₂ or NH₃.

Subsequently, the second purge step for removing a reacted byproduct and a reaction gas or an ignition gas from the chamber is performed in the step S240.

The silicon deposition step S210, the first purge step S220, the reaction step S230 and the second purge step S240 may be repeatedly performed. The silicon deposition step S210, the first purge step S220, the reaction step S230 and the second purge step S240, for example, may be repeated three to ten times.

A temperature of the substrate and a pressure inside the chamber may be constantly maintained in the step S200 of depositing the insulating film including the silicon deposition step S210, the first purge step S220, the reaction step S230 and the second purge step S240.

In each silicon deposition step S210, at least one silicon atomic layer may be formed on the substrate. The insulating film including silicon may be formed to have a thickness of several or tens of A. After forming the insulating film including silicon, a step of densifying the insulting film including silicon is performed in a step S300.

To densify the insulating film including silicon, a plasma atmosphere may be formed inside the chamber. Also, together with the plasma atmosphere, a second reaction gas may be additionally injected into the chamber. The second reaction gas, for example, may be one or more gases selected from the group consisting of O₂, O₃, N₂, and NH₃.

To obtain an insulating film including silicon and having a desired thickness, the step S200 of depositing the insulating film and step S300 of densifying the insulting film may be repeatedly performed as needed in a step S400.

When the insulating film including silicon and having a desired thickness is formed, the substrate may be unloaded from the chamber in a step S900.

FIG. 2 is a sectional view schematically illustrating a semiconductor manufacturing apparatus for performing a method of depositing a cyclic thin film, according to an embodiment of the present invention.

Referring to FIG. 2, an introduction part 12 for introducing a reaction gas into a chamber 11 of a semiconductor manufacturing apparatus 10 is formed. The reaction gas introduced by the introduction part 12 may be sprayed into the chamber 11 through a shower head 13.

A substrate 100 for deposition is disposed on a chuck 14, which is supported by a chuck support 16. If necessary, the chuck 14 applies heat to the substrate 100 such that the substrate 100 has a certain temperature. Deposition is performed by the semiconductor manufacturing apparatus 10 and thereafter, discharge is performed by a discharge part 17.

Moreover, to form a plasma atmosphere, the semiconductor manufacturing apparatus 10 may include a plasma generation part 18.

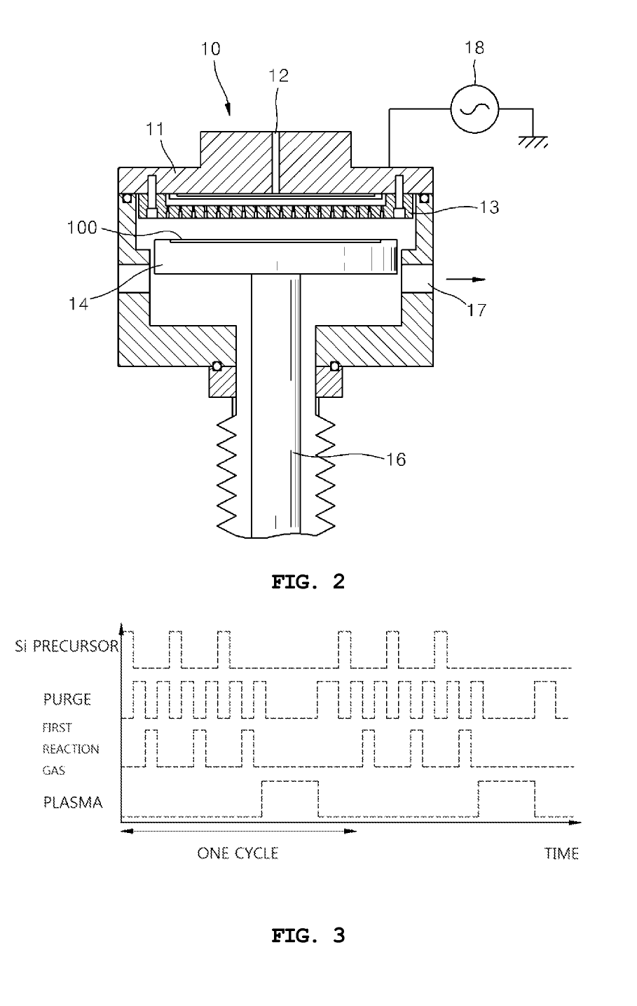

FIG. 3 is a diagram describing a method of depositing a cyclic thin film according to an embodiment of the present invention.

Referring to FIG. 3, the injection and purge of a silicon precursor and the injection and purge of the first reaction gas are repeatedly performed. Purge after the injection of the silicon precursor and purge after the injection of the first reaction gas are repeatedly performed, and then a plasma atmosphere is formed. In a state where the plasma atmosphere has been formed, a second reaction gas may be injected as necessary.

As such, from the steps in which the injection and purge of the silicon precursor and the injection and purge of the first reaction gas are repeatedly performed and to the step in which the plasma atmosphere is formed, is performed as one cycle. That is, the insulating film including silicon is formed by repeatedly performing the injection and purge of a silicon precursor and the injection and purge of a reaction gas, and thereafter, the insulating film including silicon is densified by forming a plasma atmosphere.

Moreover, by repeating all the above-described steps, an insulating film including silicon and having a desired thickness can be obtained.

Accordingly, the method of depositing the cyclic thin film can be performed by repeatedly performing the injection and purge of the silicon precursor and the injection and purge of the first reaction gas, and moreover by repeatedly performing the steps of forming and densifying the insulating film including silicon.

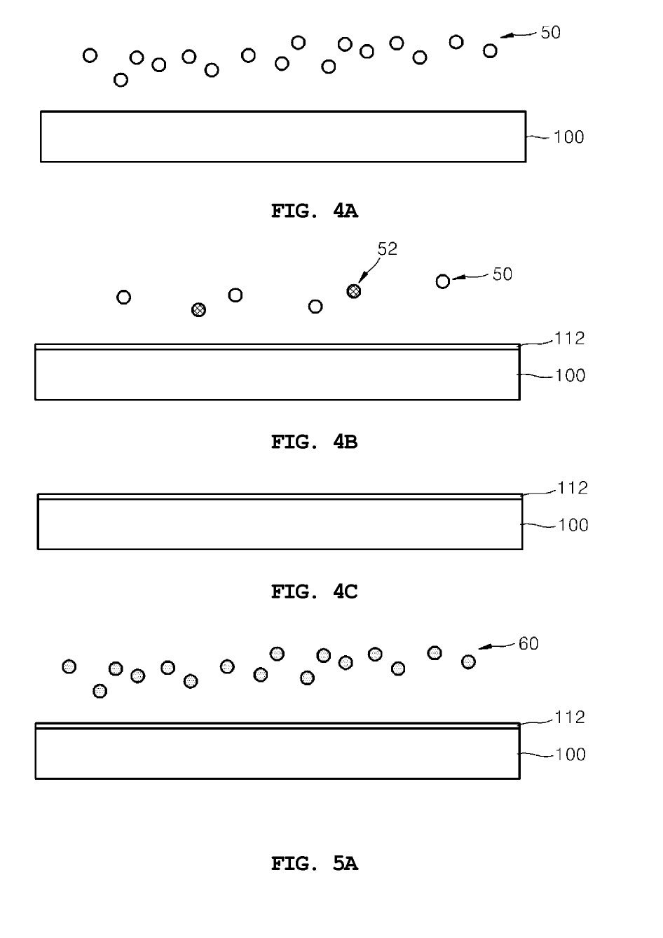

The method of depositing the cyclic thin film according to an embodiment of the present invention will be specifically described on a step-by-step with reference to FIG. 4A to 8 based on the above description. In the following description on FIG. 4A to 8, reference numbers of FIGS. 1 to 3 may be used as necessary.

FIG. 4A to 4C are sectional views illustrating a step of depositing silicon according to an embodiment of the present invention. FIG. 4A is a sectional view illustrating a step of injecting a silicon precursor according to an embodiment of the present invention.

Referring to FIG. 4A, a silicon precursor 50 is injected into the chamber 11 into which the substrate 100 is loaded.

The substrate 100, for example, may include a semiconductor substrate such as a silicon or compound semiconductor wafer. Alternatively, the substrate 100 may include a substrate material, which differs from a semiconductor, such as glass, metal, ceramic and quartz.

The silicon precursor 50, for example, may be amino-based silane such as bisethylmethylaminosilane (BEMAS), bisdimethylaminosilane (BDMAS), BEDAS, tetrakisethylmethylaminosilane (TEMAS), tetrakisidimethylaminosilane (TDMAS), and TEDAS, or chloride-based silane such as hexachlorinedisilane (HCD).

The substrate 100 may be maintained at a temperature of about 50° C. to about 600° C. for reacting with the silicon precursor 50. Also, a pressure inside the chamber 11 into which the substrate 100 is loaded may be maintained about 0.05 Torr to about 10 Torr.

FIG. 4B is a sectional view illustrating a step of depositing silicon on the substrate according to an embodiment of the present invention. Referring to FIG. 4B, by a portion of the silicon precursors 50 reacting with the substrate 100, a silicon atom may be deposited on the substrate 100 and thus a silicon layer 112 may be formed. The silicon layer 112 may be formed of at least one silicon atomic layer.

A portion of the silicon precursors 50 may react with the substrate 100, thereby forming one or more reacted byproducts 52. Also, the other of the silicon precursors 50 may be remained in a non-reacted state without reacting with the substrate 100.

FIG. 4C is a sectional view illustrating a step of performing a first purge step according to an embodiment of the present invention. Referring to FIG. 4C, the silicon layer 112 is formed on the substrate 100 and then a purge step, which removes the remaining silicon precursors 50 in a non-reacted state and the reacted byproducts 52 from the chamber 11, may be performed. The purge step, which removes the remaining silicon precursors 50 and the reacted byproducts 52 from the chamber 11, may be called as a first purge step.

In the first purge step, the substrate 100 may be maintained at a temperature of about 50° C. to about 600° C. Also, a pressure inside the chamber 11 into which the substrate 100 is loaded may be maintained about 0.05 Torr to about 10 Torr. That is, a temperature of the substrate 100 and a pressure inside the chamber 11 may be constantly maintained in the step of depositing the silicon layer 112 and the first purge step.

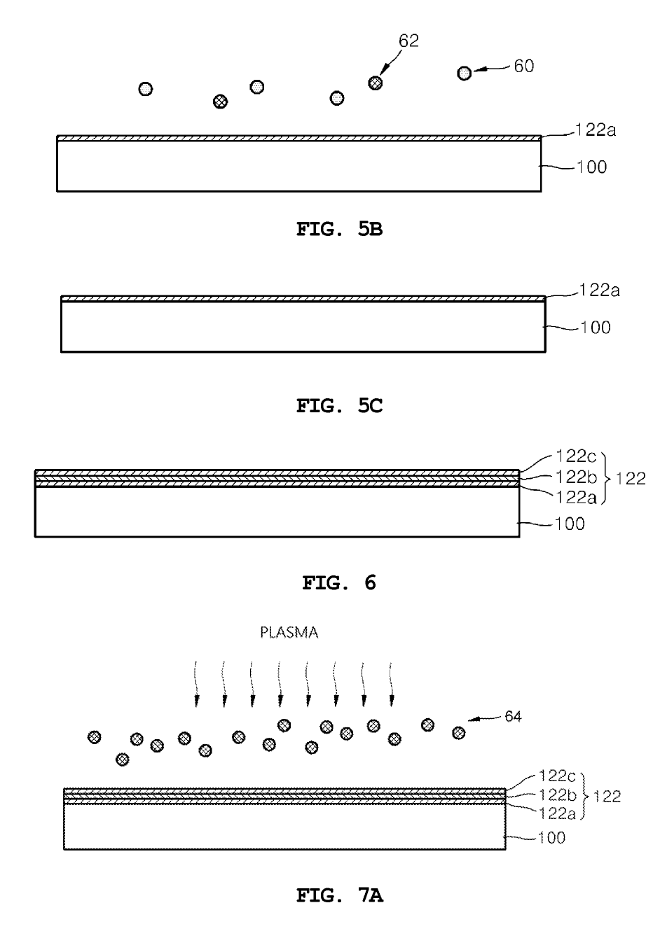

FIG. 5A to 5C are sectional views illustrating a step of forming an insulating film including silicon according to an embodiment of the present invention. FIG. 5A is a sectional view illustrating a step of injecting a reaction gas according to an embodiment of the present invention.

Referring to FIG. 5A, a first reaction gas 60 is injected into the chamber 11 into which the substrate 100 is loaded. The first reaction gas 60, for example, may be one or more gases selected from the group consisting of O₂, O₃, N₂, and NH₃. Alternatively, the first reaction gas 60, for example, may be O_{*} (oxygen radical) or O_{2—} (oxygen anion) that is formed by using plasma at an O₂ atmosphere.

The substrate 100 may be maintained at a temperature of about 50° C. to about 600° C. for reacting with the first reaction gas 60. Also, a pressure inside the chamber 11 into which the substrate 100 is loaded may be maintained about 0.05 Torr to about 10 Torr.

FIG. 5B is a sectional view illustrating a step of depositing an insulating film including silicon on a substrate according to an embodiment of the present invention. Referring to FIG. 5B, by a portion of the first reaction gas 60 reacting with the silicon layer 112, the insulating film 122a including silicon may be formed on the substrate 100.

The first reaction gas 60 may react with the silicon layer 112, thereby forming a reacted byproduct 62. Also, the other portion of the first reaction gas 60 may be remained in a non-reacted state without reacting with the silicon layer 112.

For example, when a gas including an oxygen atom such as O₂ or O₃ is used as the first reaction gas 60, or O_{*} (oxygen radical) or O_{2—} (oxygen anion) that is formed of plasma at an O₂ atmosphere is used as the first reaction gas 60, the silicon layer 112 may react with the oxygen atom included in the first reaction gas 60 and thus be formed as a silicon oxide layer. Alternatively, when a gas including a nitrogen atom such as N₂ or NH₃ is used as the first reaction gas 60, the silicon layer 112 may react with the nitrogen atom included in the first reaction gas 60 and thus be formed as a silicon nitride layer.

FIG. 5C is a sectional view illustrating a step of performing the second purge step according to an embodiment of the present invention. Referring to FIG. 5C, the insulating film 112a including silicon is formed on the substrate 100, and then a purge step, which removes the remaining first reaction gas 60 in a non-reacted state and the reacted byproducts 62 from the chamber 11, may be performed. The purge step, which removes the remaining first reaction gas 60 and the reacted byproducts 62 from the chamber 11, may be called as the second purge step.

In the second purge step, the substrate 100 may be maintained at a temperature of about 50° C. to about 600° C. Also, a pressure inside the chamber 11 into which the substrate 100 is loaded may be maintained about 0.05 Torr to about 10 Torr.

FIG. 6 is a sectional view illustrating forming a plurality of insulating films including silicon according to an embodiment of the present invention.

Referring to FIG. 6, by repeating the steps of FIG. 4A to 5C, an insulating film 122 including a plurality of insulating films 122a to 122c including silicon is formed.

The insulating film 122 may have a thickness of several or tens of Å. A step of depositing each insulating film 122a, 122b or 122c including silicon may be repeatedly performed three to ten times such that the insulating film 122 includes three to ten insulating films 122a to 122c including silicon.

In this way, when the insulating film 122 is formed to include the plurality of insulating films 122a to 122c including silicon, the insulating film 122 can have excellent film properties and step coverage.

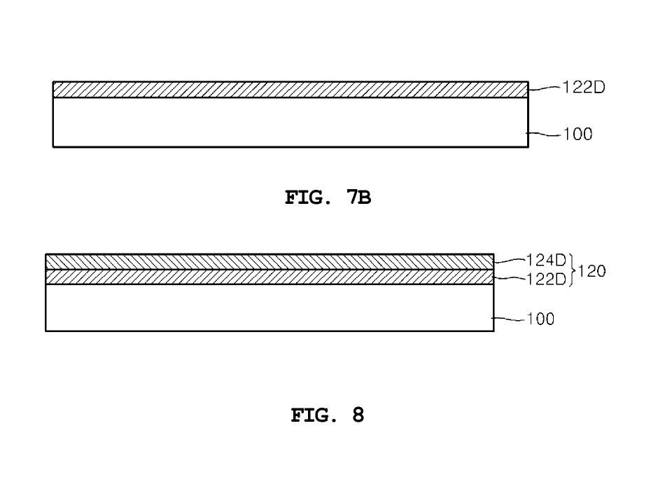

FIGS. 7A and 7B are sectional views illustrating a step of densifying the insulating film according to an embodiment of the present invention. FIG. 7A is a sectional view illustrating a step of supplying a plasma atmosphere to the insulating film, according to an embodiment of the present invention.

Referring to FIG. 7A, plasma is applied onto the substrate 100 where the insulating film 122 is formed. That is, a plasma atmosphere is formed inside the chamber 11 into which the substrate 100 is loaded. To form the plasma atmosphere, Inductively Coupled Plasma (ICP), Capacitively Coupled Plasma (CCP) or Microwave (MW) Plasma may be used. In this time, a power of about 100 W to about 3 kW may be applied for forming the plasma atmosphere.

To form the plasma atmosphere, one or more ignition gases selected from the group consisting of Ar, He, Kr, and Xe may be injected. In this case, the ignition gas may be injected at a flow rate of about 100 sccm to about 3000 sccm.

A second reaction gas 64 may be additionally injected for more densifying the insulating film 122 at the plasma atmosphere. The second reaction gas 64, for example, may be one or more gases selected from the group consisting of O₂, O₃, N₂, and NH₃, or be O_{*} (oxygen radical) or O_{2—} (oxygen anion) that is formed of plasma at an O₂ atmosphere.

For example, when the insulating film 122 is the silicon oxide film, a gas including an oxygen atom such as O₂ or O₃ may be used as the second reaction gas 64, O_{*} (oxygen radical) or O_{2—} (oxygen anion) that is formed of plasma at the O₂ atmosphere may be used as the second reaction gas 64, or H₂ may be used as the second reaction gas 64.

For example, when the insulating film 122 is the silicon nitride film, a gas including a nitrogen atom such as N₂ or NH₃ may be used as the second reaction gas 64, or H₂ may be used as the second reaction gas 64.

FIG. 7B is a sectional view illustrating the step of forming a densified insulating film 122D according to an embodiment of the present invention. Referring to FIGS. 7A and 7B, the insulating film 122 may be densified at the plasma atmosphere and thus the densified insulating film 122D may be formed. To form the densified insulating film 122D, a pressure inside the chamber 11 into which the substrate 100 is loaded may be maintained about 0.05 Torr to about 10 Torr.

Also, the densified insulating film 122D that is obtained by processing the insulating film 122 at the plasma atmosphere can have good film properties in insulating characteristic. Particularly, even when the densified insulating film 122D is formed to have a thin thickness, the densified insulating film 122D can have good film properties.

FIG. 8 is a sectional view illustrating an insulating film including silicon according to another embodiment of the present invention. Referring to FIG. 8, the insulating film 120 including a plurality of the densified insulating films 122D and 124D may be formed by repeating the steps described above with reference to FIGS. 4A to 7B.

If the insulating film 122 shown in FIG. 7A is relatively thick, the influence of plasma or the second reaction gas 64 on a lower portion of the insulating film 122 is relatively less. Therefore, in order to further enhance the film properties of the insulating film 120, the insulating film 120 including the densified insulating films 122D and 124D may be formed to have a relatively thinner thickness.

Moreover, although the insulating film 120 is illustrated as including the two densified insulating films 122D and 124D, the insulating film 120 may include three or more densified insulating films. That is, the number of densified insulating films included in the insulating film 120 may be determined in consideration of the desired thickness of the insulating film 120. In other words, the number of times the steps of FIGS. 4A to 7B are repeated may be determined in consideration of the desired thickness of the insulating film 120.

The method of depositing the cyclic thin film according to an embodiment of the present invention can form the insulating film (for example, a silicon oxide layer or a silicon nitride layer) having excellent film properties and step coverage.

Accordingly, the insulating film with a thin thickness can be formed for realizing a highly-integrated semiconductor device and moreover since the insulating film has excellent step coverage, the fine structure can be realized. Also, since the insulating film has good film properties, the method of depositing the cyclic thin film can satisfy performance required by highly-integrated semiconductor devices.

The present invention has been described above through preferred embodiments, but the present invention may be implemented with other embodiments. Therefore, the technical spirit and scope of the below-described claims are not limited to the preferred embodiments.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

What is claimed is:

1. A method of depositing a cyclic thin film, the method comprising the steps of:
depositing an insulating film by repeatedly performing a deposition step for depositing silicon on a substrate by injecting a silicon precursor into a chamber into which the substrate is loaded, a first purge step for removing a non-reacted silicon precursor and a reacted byproduct from the chamber, a reaction step for forming the deposited silicon as an insulating film including silicon by supplying a first reaction gas into the chamber and a second purge step for removing a non-reacted first reaction gas and a reacted byproduct from the chamber; and
densifying the insulating film including silicon by supplying a plasma atmosphere into the chamber.

2. The method of claim 1, wherein the first reaction gas is one or more gases selected from a group consisting of O₂, O₃, N₂, and NH₃.

3. The method of claim 2, wherein the insulating film including silicon is a silicon oxide film or a silicon nitride film.

4. The method of claim 2, wherein the step of densifying comprises forming the plasma atmosphere by injecting one or more ignition gases selected from a group consisting of Ar, He, Kr, and Xe.

5. The method of claim 1, wherein the reaction step uses O_{*} (oxygen radical) or O_{2—} (oxygen anion), formed by using plasma at an O₂ atmosphere, as the first reaction gas.

6. The method of claim 4, wherein the step of densifying the insulating film including silicon comprising further injecting the ignition gas and one or more second reaction gases selected from a group consisting of O₂, O₃, N₂, and NH₃.

7. The method of claim 1, wherein the step of depositing the insulating film is performed while maintaining a pressure inside the chamber as 0.05 Torr to 10 Torr.

8. The method of claim 1, wherein the step of densifying the insulating film including silicon is performed while maintaining a pressure inside the chamber as 0.05 Torr to 10 Torr.

9. The method of claim 1, wherein the deposition step, the first purge step, the reaction step and the second purge step are repeatedly performed three to ten times, before the step of densifying the insulating film including silicon.

10. The method of claim 1, wherein the steps of depositing the insulating film and densifying the insulating film including silicon are repeatedly performed.
